(19) United States
(12) Patent Application Publication
(10) Pub. No.: US 2026/0021744 A1
(43) Pub. Date: Jan. 22, 2026

(54) SYSTEMS, DEVICES, AND METHODS FOR A COOLING PLATE PORT CONNECTOR FOR A VEHICLE

(71) Applicant: Toyota Motor Engineering & Manufacturing North America, Inc., Plano, TX (US)

(72) Inventor: Christopher N. Wimsatt, Finchville, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/774,230

(22) Filed: Jul. 16, 2024

(51) Int. Cl. B60L 58/26; H01M 10/613; H01M 10/625; H01M 10/6556; H01M 10/6568

(52) U.S. Cl. CPC B60L 58/26; H01M 10/613; H01M 10/625; H01M 10/6556; H01M 10/6568; H01M 2220/20

(57) ABSTRACT

Systems, devices, and methods for a cooling plate connector for a vehicle. The cooling plate connector may include a body configured to carry coolant therethrough. The body may have a first end and a second end opposite the first end, the second end being configured to fluidly couple to a cooling plate of the vehicle. The cooling plate connector may further have a spout in fluid communication with the body and positioned at the first end of the body. The cooling plate connector may further have a sealant manifold positioned at the second end of the body. The sealant manifold may be configured to receive sealant and guide the sealant to seal the second end of the body to the cooling plate.

### BACKGROUND

### 1. Field

The present disclosure relates to systems, devices, and/or methods for a cooling plate port connector for a vehicle.

### 2. Description of the Related Art

Certain vehicles, such as battery electric vehicles (BEVs) and/or hybrid electric vehicles (HEVs), may include large batteries that require cooling. These large batteries may be cooled with liquid based cooling systems. However, current cooling systems may utilize connections between components of the cooling systems that are laborious and/or expensive to manufacture. For example, current cooling systems may utilize braised and/or welded connections between certain components of the cooling systems. Moreover, the connections between the components of the cooling systems may have large and/or tall profiles which may cause the connections to snag on other components of the vehicles during installation and/or removal.

Accordingly, it is desirable to provide systems, devices, and methods for a cooling plate port connector for a vehicle.

### SUMMARY

In general, one aspect of the subject matter described in this disclosure may be embodied in a cooling plate connector for a vehicle. The cooling plate connector may include a body configured to carry coolant therethrough. The body may have a first end and a second end opposite the first end, the second end being configured to fluidly couple to a cooling plate of the vehicle. The cooling plate connector may further have a spout in fluid communication with the body and positioned at the first end of the body. The cooling plate connector may further have a sealant manifold positioned at the second end of the body. The sealant manifold may be configured to receive sealant and guide the sealant to seal the second end of the body to the cooling plate.

In one aspect, the subject matter may be embodied in a cooling plate system for a vehicle. The cooling plate system may include a cooling plate. The cooling plate may have an internal volume configured to receive coolant. The cooling plate may further have a port in fluid communication with the internal volume. The cooling plate system may further include a cooling plate connector. The cooling plate connector may have a body configured to carry coolant therethrough. The body may have a first end and a second end opposite the first end, the second end being configured to fluidly couple to the port. The cooling plate connector may further include a spout in fluid communication with the body and positioned at the first end of the body. The cooling plate connector may further include a sealant manifold. The sealant manifold may be configured to receive sealant and guide the sealant to seal a joint formed between the second end of the body and the port.

In one aspect, the subject matter may be embodied in a method for fluidly coupling a cooling plate connector to a cooling plate of a vehicle. The method may include inserting an end of the cooling plate connector into a port of the cooling plate such that a lip of the cooling plate connector engages an edge of the port. The method may further include rotating the cooling plate connector toward the cooling plate until the cooling plate connector is flush with a surface of the cooling plate. The method may further include placing a fastener through a body of the cooling plate connector to secure the cooling plate connector to the cooling plate. The method may further include injecting a sealant into a sealant manifold of the cooling plate connector to seal a joint formed between the end of the cooling plate connector and the port of the cooling plate.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a schematic of an example vehicle with which an example cooling plate connector may be implemented according to an aspect of the disclosure.

FIG. 2 is a perspective view of a portion of the example cooling plate of FIG. 1 according to an aspect of the disclosure.

FIG. 3 is a perspective view of the example cooling plate connector of FIG. 1 fluidly coupled to the example cooling plate of FIG. 2 according to an aspect of the disclosure.

FIG. 4 is a cross-sectional side view of the example cooling plate connector of FIG. 3 and the example cooling plate of FIG. 3 according to an aspect of the disclosure.

FIG. 5 is a cross-sectional top view of a port of the example cooling plate of FIG. 3 according to an aspect of the disclosure.

FIG. 6 is a cross-sectional side view of an example cooling plate and an example cooling plate connector illustrating a step in fluidly coupling the example cooling plate connector to the example cooling plate according to an aspect of the disclosure.

FIG. 7 is a perspective view of the example cooling plate of FIG. 6 and the example cooling plate connector of FIG. 6 during a subsequent step in fluidly coupling the example cooling plate connector to the example cooling plate according to an aspect of the disclosure.

FIG. 8 is a perspective view of the example cooling plate of FIG. 7 and the example cooling plate connector of FIG. 7 during a subsequent step in fluidly coupling the example cooling plate connector to the example cooling plate according to an aspect of the disclosure.

FIG. 9 is a top view of the example cooling plate of FIG. 8 and the example cooling plate connector of FIG. 8 during a subsequent step in fluidly coupling the example cooling plate connector to the example cooling plate according to an aspect of the disclosure.

FIG. 10 is a top view of the example cooling plate of FIG. 9 and the example cooling plate connector of FIG. 9 during a subsequent step in fluidly coupling the example cooling plate connector to the example cooling plate according to an aspect of the disclosure.

FIG. 11 illustrates an example method for fluidly coupling a cooling plate connector to a cooling plate according to an aspect of the disclosure.

### DETAILED DESCRIPTION

Disclosed herein are systems, devices, vehicles, and/or methods for implementing a cooling plate port connector for a vehicle. Particular embodiments of the subject matter described in this disclosure may be implemented to realize one or more of the following advantages. The cooling plate port connector may fluidly couple to a port of a cooling plate of the vehicle. The cooling plate may be configured to cool a battery of the vehicle. The cooling plate port connector may fluidly couple to a coolant hose (or line) of the vehicle to fluidly couple the cooling plate to a cooling system (or circuit) of the vehicle such that the cooling plate may cool the battery with circulating coolant.

Moreover, the cooling plate port connector may include a sealant manifold configured to receive and guide sealant to seal an end of the cooling plate port connector to the port. The sealant manifold may enable the formation of a hermetic coolant flow path between the cooling plate and the coolant hose.

Moreover, the cooling plate port connector may have a low profile such that the cooling plate port connector does not snag on other components of the vehicle during servicing of the vehicle and/or installation or removal of the cooling plate port connector.

Moreover, the cooling plate port connector may provide for a less expensive and less laborious connection between the cooling plate and the cooling system compared to conventional connections, such as braised and/or welded connections. For example, the cooling plate port connector may be secured to the cooling plate with a single fastener by having a lip configured to engage with the port of the cooling plate.

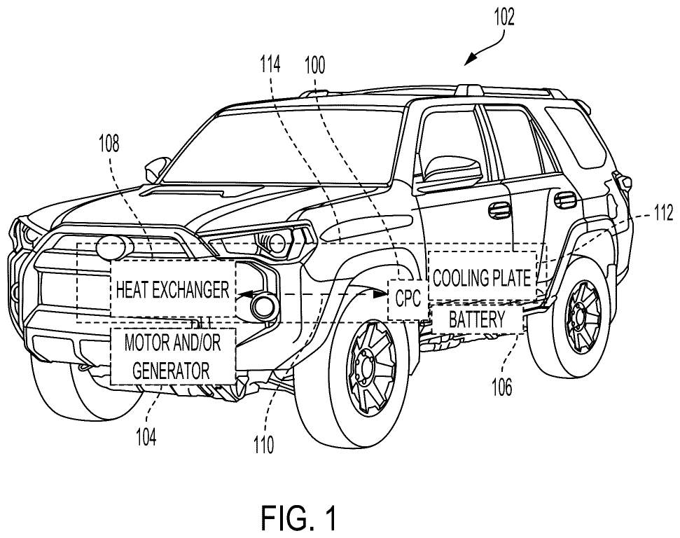

FIG. 1 illustrates an example vehicle 102 in which an example cooling plate connector 100 (also may be referred to as a cooling plate port connector 100) may be implemented. The cooling plate connector 100 may be retrofitted, coupled to, include, or be included within the vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The vehicle 102 may include a motor and/or generator 104, a battery 106, and/or a cooling system 114. The motor and/or generator 104 may be located within an engine bay of the vehicle 102. In examples, the motor and/or generator 104 may be located at and/or adjacent to one or more axles of the vehicle 102 such that the vehicle 102 includes one motor and/or generator 104 or a plurality of motors and/or generators. The motor and/or generator 104 may be an internal combustion engine (ICE). In this regard, the motor and/or generator 104 may combust an air and fuel mixture to provide power to the vehicle 102 and/or components of the vehicle 102. Accordingly, the motor and/or generator 104 can cause the vehicle 102 to accelerate, decelerate, or maintain a desired velocity. The motor and/or generator 104 may include combinations of an ICE and an electric motor, such as for hybrid electric vehicle (HEV) applications for example. In examples, the motor and/or generator 104 may be an electric motor, such as for battery electric vehicle (BEV) applications for example. In this regard, the motor and/or generator 104 may be an electric motor and/or an electric generator that converts electrical energy into mechanical power, such as torque, and converts mechanical power into electrical energy. The motor and/or generator 104 may be electrically connected to the battery 106. The motor and/or generator 104 may convert energy from the battery 106 into mechanical power, and may provide energy back to the battery 106, for example, via regenerative braking.

The battery 106 may be retrofitted, coupled to, include or be included within the vehicle 102. The battery 106 may be electrically connected to the motor and/or generator 104 and/or other components of the vehicle 102. The battery 106 may be positioned at, along, and/or near an undercarriage of the vehicle 102. The battery 106 may store chemical energy for later conversion to electrical energy. The battery 106 may provide the electrical energy to and/or receive electrical energy from the motor and/or generator 104 and/or other components of the vehicle 102. The battery 106 may be a battery pack that includes one or more battery modules and/or a power management system (BMS). The one or more battery modules may each include one or more cells. The one or more cells may be cylindrical cells, prismatic cells, and/or pouch cells (in examples, other types of cells may be used). A chemistry of the one or more cells may be lithium ion (Li-Ion), nickel manganese cobalt (NMC), nickel metal hydride (Ni-MH), lithium sulfur (Li—S), and/or lead-acid (in examples, other chemistries may be used).

The cooling system 114 may include the cooling plate connector 100, a cooling plate 112, a heat exchanger 108, and/or one or more coolant lines (or hoses) 110. In examples, the cooling system 114 may include one or more temperature sensors, fans, pumps, radiators, evaporator cores, and/or heat sinks for circulating and/or cooling coolant (e.g., water, ethylene glycol, oil, etc.) within the cooling system 114. The cooling system 114 may be configured to control a temperature of the battery 106 by cooling the battery 106. For example, the cooling system 114 may circulate coolant through the cooling plate connector 100, the cooling plate 112, the heat exchanger 108, and the one or more coolant lines 110 to cool the battery 106. Thus, in examples, the cooling system 114 may be or form a cooling circuit comprising the cooling plate connector 100, the cooling plate 112, the heat exchanger 108, and/or the one or more coolant lines 110. The cooling system 114 may transfer heat from the battery 106 to the heat exchanger 108 to dissipate the heat and cool the battery 106 (e.g., by circulating coolant through the cooling circuit). In examples, the cooling system 114 may be configured to control a temperature of one or more other components of the vehicle 102, such as a transmission (not shown) and/or the motor and/or generator 104, in addition to the battery 106 or as an alternative to the battery 106.

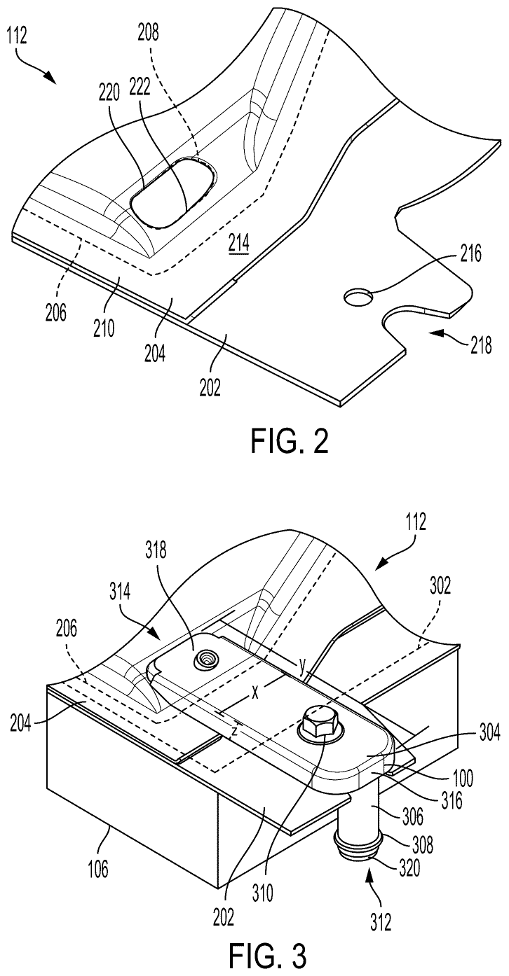

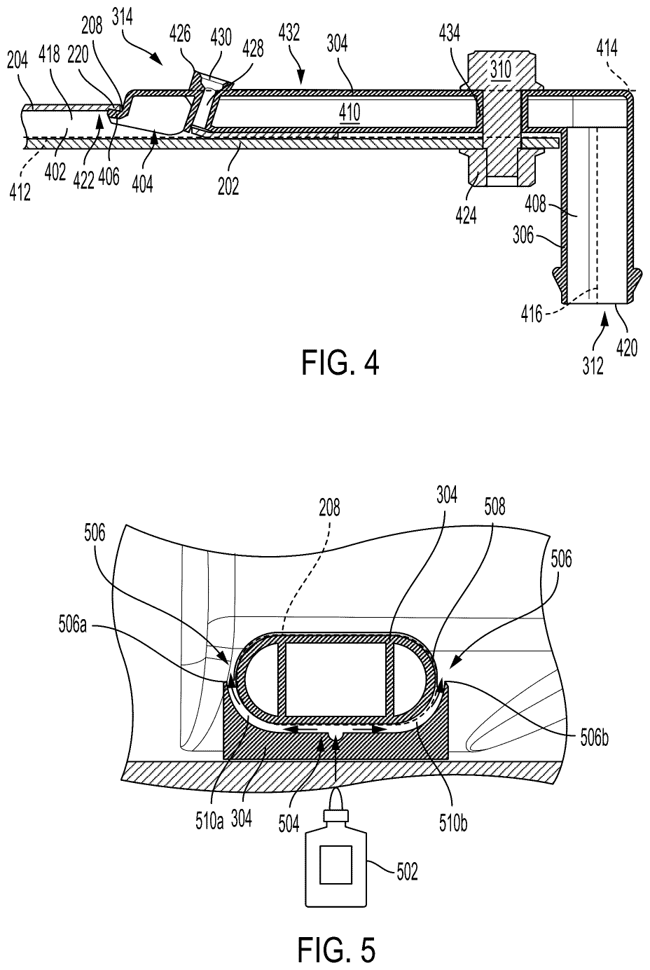

FIG. 2 is a schematic illustrating the cooling plate 112 and FIG. 3 is a schematic illustrating the cooling plate 112 coupled to the battery 106. Referring to FIG. 2 and FIG. 3 with continuing reference to FIG. 1, the cooling plate 112 may include a base plate (or bottom plate or first half) 202 and a reservoir plate (or top plate or second half) 204. The base plate 202 may be coupled to the reservoir plate 204 via one or more first welds 206 between the base plate 202 and a flange 210 of the reservoir plate 204. In examples, the base plate 202 and the reservoir plate 204 may be coupled, welded, and/or bonded together through the use of a bonding agent, a gasket, a sealant, an adhesive, and/or one or more fasteners (e.g., bolts, screws, rivets, etc.). The base plate 202 may define and/or be positioned along a first horizontal plane 412 (marked in FIG. 4).

The base plate 202 may be configured to couple the cooling plate 112 to the battery 106 and/or a frame housing the battery 106. For example, the base plate 202 may couple the cooling plate 112 to the battery 106 via one or more second welds 302 between the base plate 202 and the battery 106 as shown in FIG. 3. In examples, the base plate 202 and the battery 106 (or the frame housing the battery 106) may be coupled, welded, and/or bonded together through the use of a bonding agent, a gasket, a sealant, an adhesive, and/or one or more fasteners (e.g., bolts, screws, rivets, etc.). The cooling plate 112 may be positioned on top of or beneath the battery 106. The base plate 202 may be made of a material having high thermal conductivity, such as aluminum (in examples the base plate 202 may be made of steel and/or other metals, alloys, and/or composites).

The base plate 202 may include and/or define a fastener hole 216 and a notch 218 for coupling and/or securing the cooling plate connector 100 to the cooling plate 112 (as described in greater detail below). The fastener hole 216 may be a through hole and may include screw threads (in examples the fastener hole 216 is not a through hole and/or does not include screw threads). The fastener hole 216 may be configured to receive a fastener 310 (marked in FIG. 3) (e.g., a bolt, a screw, a rivet, etc.) for coupling and/or securing the cooling plate connector 100 to the cooling plate 112.

Referring briefly to FIG. 4 with continuing reference to FIG. 2, the reservoir plate 204 may be shaped such that when the reservoir plate 204 is coupled to the base plate 202, an internal volume 402 of the cooling plate 112 is formed. The internal volume 402 of the cooling plate 112 may be defined by an internal surface 418 of the cooling plate 112. The internal surface 418 of the cooling plate 112 may include an internal surface of the reservoir plate 204 and an internal surface of the base plate 202. The internal volume 402 of the cooling plate 112 may be configured to receive and/or hold coolant. In examples, the internal volume 402 of the cooling plate 112 may be and/or include a cooling channel configured to carry (or pass) coolant therethrough.

The reservoir plate 204 may be made of a material having high thermal conductivity, such as aluminum (in examples the reservoir plate 204 may be made of steel and/or other metals, alloys, and/or composites). The reservoir plate 204 and the base plate 202 may be made of the same material (in examples, the reservoir plate 204 and the base plate 202 may be made of different materials).

Referring again to FIG. 2 with continuing reference to FIGS. 3 and 4, the reservoir plate 204 may include a port 208. The port 208 may be a cooling channel opening. The port 208 may include a top (or first) edge 220 and a bottom (or second) edge 222. The port 208 may be in fluid communication with the internal volume 402 of the cooling plate 112. For example, coolant may flow through the port 208 and into and/or out of the internal volume 402 of the cooling plate 112. In examples, the reservoir plate 204 and/or the base plate 202 may include a plurality of ports.

The cooling plate 112 may be configured to receive (e.g., via the port 208) and/or hold coolant within the internal volume 402 of the cooling plate 112. For example, the cooling system 114 (marked in FIG. 1) may provide coolant to and/or circulate coolant through the internal volume 402 of the cooling plate 112. The cooling plate 112 may be coupled to the battery 106 such that heat from the battery 106 may be transferred to the cooling plate 112. The heat transferred from the battery 106 to the cooling plate 112 may heat up the coolant within the internal volume 402 of the cooling plate 112. The cooling plate 112 may dissipate the heat from the battery 106 by, for example, having a large outer surface 214 such that the heat is dissipated into air around the cooling plate 112 (e.g., air that is in contact with the outer surface 214 of the cooling plate 112). In addition or alternatively, the cooling plate 112 may dissipate the heat from the battery 106 by the cooling system 114 circulating coolant within or through the cooling plate 112 such that the heat may be dissipated using the heat exchanger 108 (marked in FIG. 1) and/or other cooling features of the cooling plate 112 and/or the cooling system 114.

Referring to FIGS. 3 and 4, the cooling plate connector 100 may be configured to fluidly couple to the cooling plate 112. For example, the cooling plate connector 100 may be configured to fluidly couple to the port 208 of the cooling plate 112 such that the cooling plate connector 100 is in fluid communication with the internal volume 402 of the cooling plate 112. The cooling plate connector 100 may fluidly couple the cooling plate 112 to other components of the cooling system 114 (marked in FIG. 1). For example, the cooling plate connector 100 may fluidly couple the one or more coolant lines 110 (marked in FIG. 1) to the cooling plate 112 such that the cooling system 114 may circulate coolant through the one or more coolant lines 110, the cooling plate connector 100, and the cooling plate 112. The cooling plate connector 100 may be configured to form a hermetic coolant path between the cooling plate 112 and the one or more coolant lines 110.

The cooling plate connector 100 may include a connector body 304. The connector body 304 may be configured to carry (or pass) coolant therethrough. For example, the connector body 304 may include an internal volume (or passageway) 410 configured to carry (or pass) the coolant therethrough. The connector body 304 may have a rectangular shape with a length “Y”, a width “X”, and a height “Z”. The connector body 304 may have a length Y such that the connector body 304 spans across the one or more first welds 206 and the one or more second welds 302. The connector body 304 may have a flat profile such that the width X of the connector body 304 is greater than the height Z of the connector body 304. For example, the width X may be 2× or 3× the height Z (in examples, the width X may be less than 2× or more than 3× the height Z). The flat profile of the connector body 304 enables the cooling plate connector 100 to have a low profile such that the cooling plate connector 100 does not interfere with other components of the vehicle 102. For example, the height Z of the connector body 304 may be less than 10 millimeters (in examples, the height Z may be less than 20 millimeters).

The connector body 304 may further have a first (or proximal) end 316 and a second (or distal) end 318 opposite the first end 316. The first end 316 and the second end 318 of the connector body 304 may define the length Y of the connector body 304. The connector body 304 may define and/or be positioned along a second horizontal plane 414. The second horizontal plane 414 may be parallel to the first horizontal plane 412.

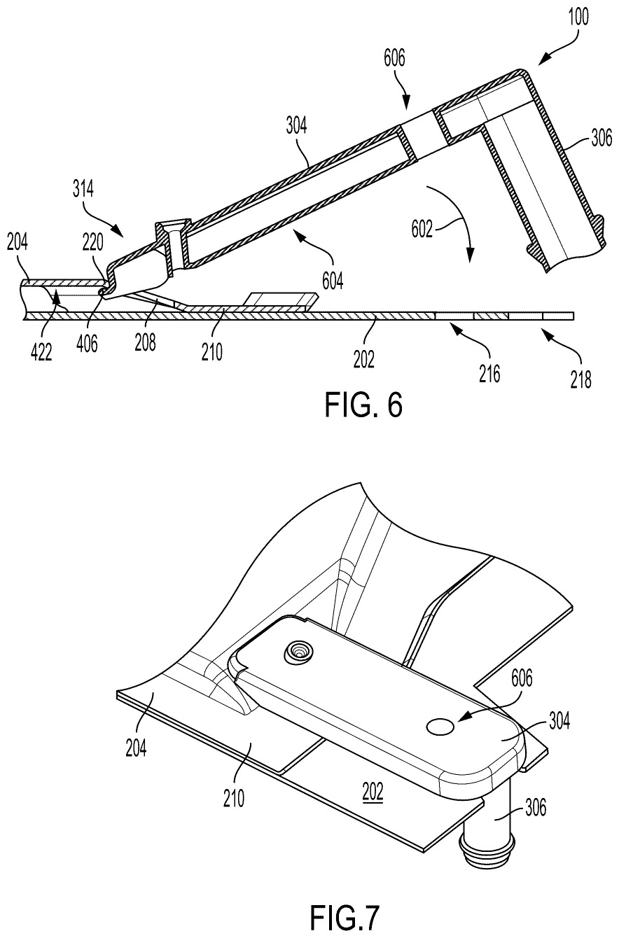

The connector body 304 may include a fastener hole 606 (marked in FIGS. 6 and 7) and/or a tunnel 434. The fastener hole 606 and the tunnel 434 may be positioned at or adjacent to the first end 316 of the connector body 304. The fastener hole 606 may be defined by the tunnel 434. The tunnel 434 may be a tube leading from a top (or first) side (or surface) 432 of the connector body 304 to a bottom (or second) side (or surface) 604 (marked in FIG. 6) of the connector body 304. The top side 432 of the connector body 304 may define and/or be positioned along the second horizontal plane 414. The tunnel 434 may be positioned through the connector body 304 such that the coolant may flow around the tunnel 434 when the coolant flows through the internal volume 410 of the connector body 304. The tunnel 434 may be configured to pass through the internal volume 410 of the connector body 304 such that the coolant does not leak out the tunnel 434 and/or the fastener hole 606. The fastener hole 606 and the tunnel 434 may be configured to receive the fastener 310 (e.g., a bolt, a screw, a rivet, etc.) for fluidly coupling and/or securing the cooling plate connector 100 to the cooling plate 112. For example, the fastener 310 may be placed into the fastener hole 606 (e.g., by a user or a machine) such that the fastener 310 passes through the tunnel 434 and the connector body 304 to reach and/or pass through the cooling plate 112 (e.g., to thread into the cooling plate 112 or a nut 424 positioned beneath or on top of the cooling plate 112). The connector body 304 may be configured to receive a single fastener 310 through the connector body 304 to couple the cooling plate connector 100 to the cooling plate 112.

The cooling plate connector 100 may have a first (or coolant line) end 312 and a second (or cooling plate) end 314. The first end 312 may be configured to fluidly couple to at least one coolant line of the one or more coolant lines 110 (marked in FIG. 1). The first end 312 of the cooling plate connector 100 may be and/or include a spout (or tube) 306. The spout 306 may be positioned at or adjacent to the first end 316 of the connector body 304 and may extend outward from the connector body 304. The spout 306 may extend along a vertical axis 416. The vertical axis 416 may be perpendicular to the length Y of the connector body 304, the first horizontal plane 412, and/or the second horizontal plane 414.

The spout 306 may include a tapered end 320 configured to facilitate coupling the at least one coolant line of the one or more coolant lines 110 to the spout 306. The spout 306 may further include at least one raised edge (or rib) 308 configured to facilitate sealing and/or securing the at least one coolant line to the spout 306. The spout 306 may be configured to carry (or pass) coolant therethrough to and/or from the connector body 304. For example, the spout 306 may have a lumen 408 defined by an internal surface of the spout 306. The lumen 408 of the spout 306 may be in fluid communication with the internal volume 410 of the connector body 304. The spout 306 and/or the first end 312 of the cooling plate connector 100 may include and/or define a first opening 420. The first opening 420 may be in fluid communication with the lumen 408 of the spout 306.

The second end 314 of the cooling plate connector 100 may be positioned at or adjacent to the second end 318 of the connector body 304. For example, the second end 314 of the cooling plate connector 100 may be the second end 318 of the connector body 304. The second end 314 of the cooling plate connector 100 and/or the second end 318 of the connector body 304 may include and/or define a second opening 404. The second opening 404 may be in fluid communication with the internal volume 410 of the connector body 304. The second end 314 of the cooling plate connector 100 may be configured to fluidly couple to the port 208. For example, when the second end 314 of the cooling plate connector 100 is fluidly coupled to the port 208 of the cooling plate 112, coolant may flow from the at least one coolant line through the first opening 420, through the lumen 408 of the spout 306, through the internal volume 410 of the connector body 304, and out the second opening 404 into the internal volume 402 of the cooling plate 112. In examples, coolant may flow from the internal volume 402 through the second opening 404, through the internal volume 410 of the connector body 304, through the lumen 408 of the spout 306, and out the first opening 420 into the at least one coolant line.

The second end 314 of the cooling plate connector 100 and/or the second end 318 of the connector body 304 may include a lip 406. The lip 406 may be configured to engage the top edge 220 of the port 208 and/or the internal surface 422 of the reservoir plate 204 to fluidly couple and/or secure the second end 314 of the cooling plate connector 100 and/or the second end 318 of the connector body 304 to the port 208. For example, the cooling plate connector 100 may be fluidly coupled and/or secured to the cooling plate 112 when the lip 406 is engaged with the top edge 220 of the port 208 and/or the internal surface 422 of the reservoir plate 204 and the fastener 310 is placed through the fastener hole 606 and the tunnel 434 and secured (e.g., threaded) to the cooling plate 112 (e.g., the base plate 202).

The cooling plate connector 100 may further include a sealant manifold 426. The sealant manifold 426 may be positioned at or adjacent to the second end 314 of the cooling plate connector 100 and/or the second end 318 of the connector body 304. The sealant manifold 426 may be configured to receive sealant 502 (marked in FIG. 5) (e.g., an adhesive, a silicone adhesive, caulk, etc.) for sealing the second end 314 of the cooling plate connector 100 and/or the second end 318 of the connector body 304 to the port 208 (e.g., by sealing the bottom edge 222 to the second end 314). The sealant manifold 426 may include a funnel (or flared rim) 430 configured to receive the sealant 502 and/or a spout of a sealant bottle, for example.

FIG. 5 illustrates a cross-sectional view of the connector body 304. Referring to FIGS. 4 and 5, the sealant manifold 426 may further include a passageway 428 and a sealant path 504. When the sealant 502 is injected into the sealant manifold 426 (e.g., via the funnel 430), the sealant 502 may flow through the passageway 428 and the sealant path 504 in the direction of the arrows shown in FIG. 5. The passageway 428 may be positioned through the internal volume 410 of the connector body 304 such that the passageway 428 guides the sealant 502 through the connector body 304. This may enable the sealant manifold 426 to guide the sealant 502 from the top side 432 of the connector body 304 to the bottom side 604 (marked in FIG. 6) of the connector body 304. This may have the benefit of guiding the sealant 502 to areas between the cooling plate 112 and the connector body 304 that would be difficult or impossible to see and/or reach without the sealant manifold 426.

The sealant path 504 may be and/or include one or more channels within the connector body 304 that are configured to guide the sealant 502 at least partially around (e.g., at least halfway around) the port 208 and/or a joint 508 formed between the port 208 and the second end 314 of the connector body 304. In examples, the one or more channels may be configured to guide the sealant 502 more than halfway around the port 208 or completely around the port 208 and/or the joint 508. The one or more channels may include a first (or left) channel 510a configured to guide the sealant 502 around a first (or left) side of the joint 508 and a second (or right) channel 510b configured to guide the sealant 502 around a second (or right) side of the joint 508. The sealant path 504 and/or the one or more channels 510a and 510b may be formed into the bottom side 604 of the connector body 304.

FIGS. 6-8 illustrate example steps of fluidly coupling the cooling plate connector 100 to the cooling plate 112. Starting with FIG. 6, the second end 314 of the cooling plate connector 100 and/or the second end 318 of the connector body 304 may be inserted (e.g., by a user or a machine) into the port 208 such that the lip 406 engages the top edge 220 of the port 208 and/or the internal surface 422 of the reservoir plate 204.

Once the lip 406 is engaged with the top edge 220 of the port 208 and/or the internal surface 422 of the reservoir plate 204, the connector body 304 may be rotated (e.g., by the user or a machine) in the direction of the arrow 602 shown in FIG. 6 (e.g., downward and/or toward the cooling plate 112). The lip 406 may be configured to function as a hinge such that the connector body 304 rotates in an arch as shown by the arrow 602. For example, the connector body 304 may be rotated toward the base plate 202 until the bottom side 604 of the connector body 304 contacts (or is flush with) the flange 210 of the reservoir plate 204 and/or the base plate 202 (as shown in FIG. 7).

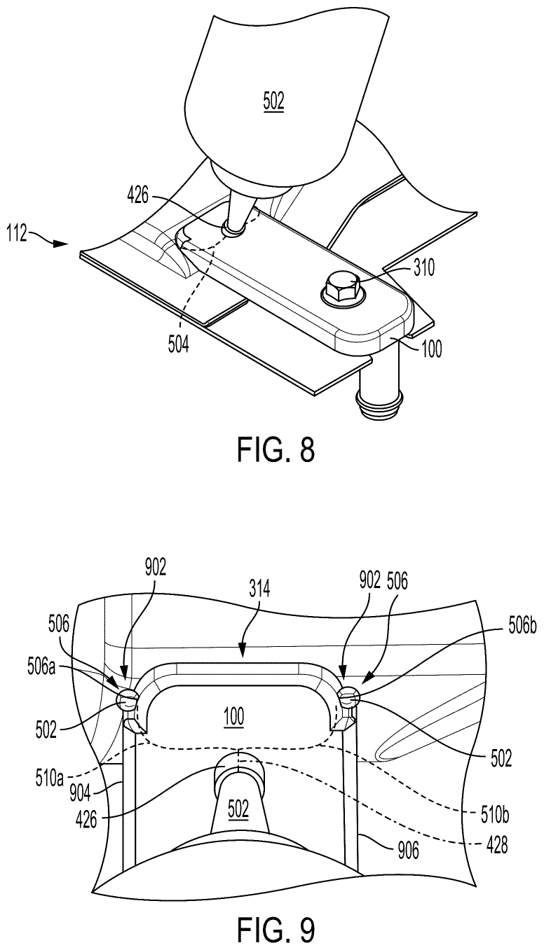

When the connector body 304 is rotated toward the base plate 202 as shown by the arrow 602, the spout 306 may pass through the notch 218 of the base plate 202 as shown in FIG. 7. The notch 218 may prevent movement (e.g., lateral movement) of the cooling plate connector 100. Moreover, when the connector body 304 is rotated toward the base plate 202 as shown by the arrow 602, the fastener hole 606 of the connector body 304 may align with the fastener hole 216 of the base plate 202 such that the fastener 310 may be placed and/or threaded through and/or into the connector body 304 and the base plate 202 as shown in FIG. 8. In examples, the nut 424 (marked in FIG. 4) may be threaded onto the fastener 310 to fluidly couple and/or secure the cooling plate connector 100 to the cooling plate 112.

When the cooling plate connector 100 is fluidly coupled and/or secured to the cooling plate 112 by the fastener 310, the sealant 502 may be injected into the sealant manifold 426 such that the sealant 502 flows through the passageway 428 and the sealant path 504 (e.g., through the one or more channels 510a and 510b of the sealant path 504) as shown in FIG. 9.

The sealant 502 may be injected into the sealant manifold 426 until the sealant 502 flows (or exits) through one or more sealant exit holes (or ports) 902 of the connector body 304 as shown in FIG. 9. The one or more sealant exit holes 902 may provide a visual indication to a user that enough sealant 502 has been injected into the sealant manifold 426 and/or that the sealant 502 has flowed through the sealant path 504 (e.g., through the one or more channels 510a and 510b of the sealant path 504). The one or more sealant exit holes 902 may be formed in the connector body 304. The one or more sealant exit holes 902 may be positioned at the second end 314 of the cooling plate connector 100 (and/or the second end 318 of the connector body 304) and/or at one or more ends 506 (shown more clearly in FIG. 5) of the sealant path 504.

The connector body 304 may include a sealant exit hole for each of the one or more channels 510a and 510b. For example, a first sealant exit hole of the one or more sealant exit holes 902 may be positioned at an end 506a of the first channel 510a and a second sealant exit hole of the one or more sealant exit holes 902 may be positioned at an end 506b of the second channel 510b. The end 506a and the first sealant exit hole may be positioned on a left (or third) side 904 of the connector body 304. The end 506b and the second sealant exit hole may be positioned on a right (or fourth) side 906 of the connector body 304. The left side 904 and the right side 906 may form walls of the connector body 304 and may each be perpendicular to the top side 432 and/or the bottom side 604 of the connector body 304.

After the sealant 502 has been injected into the sealant manifold 426 until the sealant 502 flows through the one or more sealant exit holes 902, the sealant 502 may be applied to an outer edge 1002 of the second end 314 of the cooling plate connector 100 to seal the second end 314 to the port 208 (e.g., to seal the top edge 220 (marked in FIG. 2) to the second end 314).

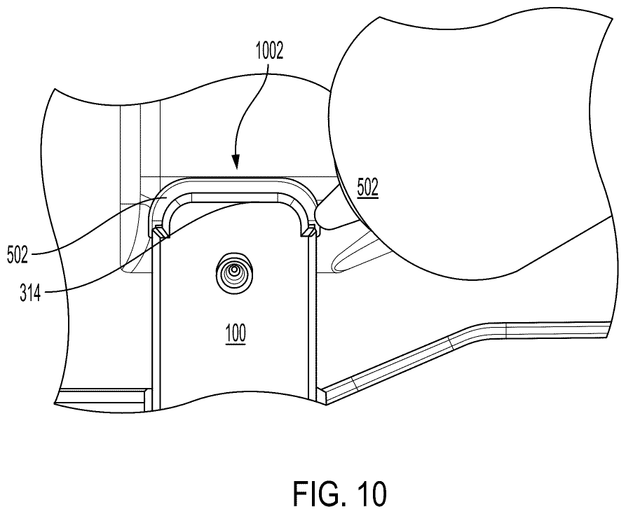

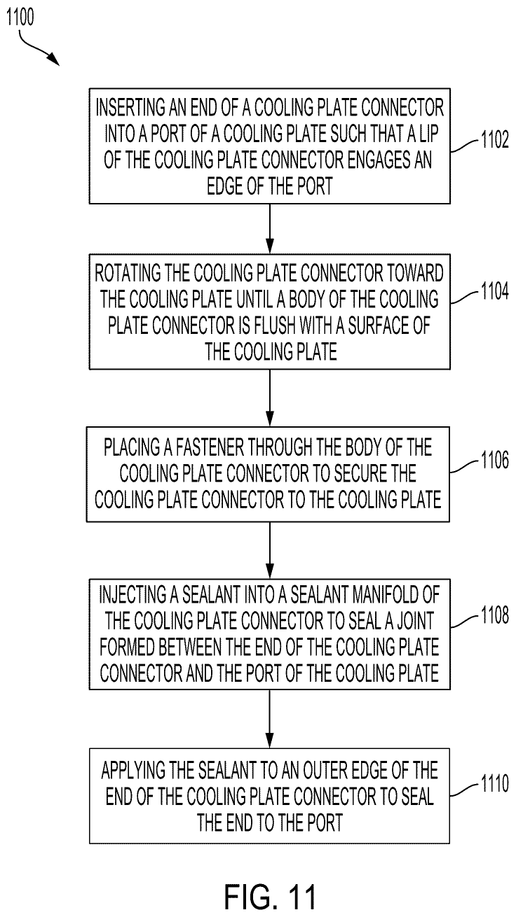

FIG. 11 is a flow diagram of an example method 1100 for fluidly coupling a cooling plate connector to a cooling plate of a vehicle. A user and/or an appropriately programmed machine (e.g., an industrial robotic arm) may implement method 1100. For ease of description, the method 1100 is described below with reference to FIGS. 1-10. The method 1100 of the present disclosure, however, is not limited to use of the exemplary cooling plate connector 100 of FIGS. 1-10.

The method 1100 may include inserting the second end 314 of the cooling plate connector 100 into the port 208 of the cooling plate 112 such that the lip 406 of the cooling plate connector 100 engages an edge (e.g., the top edge 220) of the port 208 (1102).

The method 1100 may further include rotating the cooling plate connector 100 toward the cooling plate 112 until the cooling plate connector 100 (e.g., the connector body 304) is flush with a surface (e.g., the base plate 202 and/or the flange 210 of the reservoir plate 204) of the cooling plate 112 (1104).

The method 1100 may further include placing the fastener 310 through the connector body 304 of the cooling plate connector 100 to secure the cooling plate connector 100 to the cooling plate 112 (1106).

The method 1100 may further include injecting the sealant 502 into the sealant manifold 426 of the cooling plate connector 100 to seal the joint 508 formed between the second end 314 of the cooling plate connector 100 and the port 208 of the cooling plate 112 (1108). In examples, the sealant 502 may be injected into the sealant manifold 426 until the sealant 502 flows through the one or more sealant exit holes 902.

The method 1100 may further include applying the sealant 502 to the outer edge 1002 of the second end 314 of the cooling plate connector 100 to seal the second end 314 to the port 208 (1110).

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A cooling plate connector for a vehicle, comprising:
a body configured to carry coolant therethrough and having a first end and a second end opposite the first end, the second end being configured to fluidly couple to a cooling plate of the vehicle;
a spout in fluid communication with the body and positioned at the first end of the body; and
a sealant manifold positioned at the second end of the body and configured to:
receive sealant, and
guide the sealant to seal the second end of the body to the cooling plate.

2. The cooling plate connector of claim 1, wherein:
the body has a first side and a second side opposite the first side;
the sealant manifold is further configured to receive the sealant from the first side of the body; and
the sealant manifold includes a passageway configured to guide the sealant from the first side of the body to the second side of the body.

3. The cooling plate connector of claim 2, wherein the sealant manifold further includes one or more channels formed into the second side of the body and in fluid communication with the passageway, the one or more channels being configured to guide the sealant from the passageway to a joint formed between the second end of the body and a port of the cooling plate.

4. The cooling plate connector of claim 3, wherein the one or more channels are further configured to guide the sealant at least halfway around the joint formed between the second end of the body and the port of the cooling plate.

5. The cooling plate connector of claim 3, wherein the body includes one or more sealant exit holes configured such that the sealant will exit the one or more sealant exit holes when the sealant has flowed through the one or more channels.

6. The cooling plate connector of claim 1, wherein:
the second end of the body is further configured to fluidly couple to a port of the cooling plate; and
the body further includes a lip configured to engage an edge of the port to couple the second end of the body to the port.

7. The cooling plate connector of claim 6, wherein the body is further configured to receive a single fastener through the body to couple the cooling plate connector to the cooling plate.

8. The cooling plate connector of claim 1, wherein the body includes a tunnel positioned through the body, the tunnel being configured to receive a fastener to secure the body to the cooling plate.

9. The cooling plate connector of claim 1, wherein the spout extends outward from the first end of the body and is configured to fluidly couple to a coolant hose of the vehicle.

10. A cooling plate system for a vehicle, comprising:
a cooling plate having:
an internal volume configured to receive coolant, and
a port in fluid communication with the internal volume; and
a cooling plate connector having:
a body configured to carry coolant therethrough and having a first end and a second end opposite the first end, the second end being configured to fluidly couple to the port,
a spout in fluid communication with the body and positioned at the first end of the body, and
a sealant manifold configured to:
receive sealant, and
guide the sealant to seal a joint formed between the second end of the body and the port.

11. The cooling plate system of claim 10, wherein:
the body has a first side and a second side opposite the first side;
the sealant manifold is further configured to receive the sealant from the first side of the body; and
the sealant manifold includes a passageway configured to guide the sealant from the first side of the body to the second side of the body.

12. The cooling plate system of claim 11, wherein:
the sealant manifold further includes one or more channels formed into the second side of the body and in fluid communication with the passageway, the one or more channels being configured to guide the sealant from the passageway to the joint.

13. The cooling plate system of claim 12, wherein the body includes one or more sealant exit holes configured such that the sealant will exit the one or more sealant exit holes when the sealant has flowed through the one or more channels.

14. The cooling plate system of claim 10, wherein the body further includes a lip configured to engage an edge of the port to couple the second end of the body to the port.

15. The cooling plate system of claim 14, wherein the body includes a tunnel positioned through the body, the tunnel being configured to receive a fastener to secure the body to the cooling plate.

16. The cooling plate system of claim 10, wherein:
the cooling plate is configured to couple to a battery of the vehicle; and
the spout extends outward from the first end of the body and is configured to fluidly couple to a coolant hose of the vehicle.

17. A method for fluidly coupling a cooling plate connector to a cooling plate of a vehicle, the method comprising:
inserting an end of the cooling plate connector into a port of the cooling plate such that a lip of the cooling plate connector engages an edge of the port;
rotating the cooling plate connector toward the cooling plate until the cooling plate connector is flush with a surface of the cooling plate;
placing a fastener through a body of the cooling plate connector to secure the cooling plate connector to the cooling plate; and
injecting a sealant into a sealant manifold of the cooling plate connector to seal a joint formed between the end of the cooling plate connector and the port of the cooling plate.

18. The method of claim 17, wherein:
the body has a first side and a second side opposite the first side;
the sealant manifold is configured to receive the sealant from the first side of the body; and
the sealant manifold includes a passageway configured to guide the sealant from the first side of the body to the second side of the body to seal the joint.

19. The method of claim 18, wherein:
the sealant manifold further includes one or more channels formed into the second side of the body and in fluid communication with the passageway, the one or more channels being configured to guide the sealant from the passageway to the joint; and
the body includes one or more sealant exit holes configured such that the sealant will exit the one or more sealant exit holes when the sealant has flowed through the one or more channels.

20. The method of claim 19, wherein the sealant is injected into the sealant manifold until the sealant flows through the one or more sealant exit holes.
